(19) United States
(12) Patent Application Publication
(10) Pub. No.: US 2014/0096606 A1
(43) Pub. Date: Apr. 10, 2014

(54) DETECTOR OF GRAVITATIONAL WAVES AND METHOD OF DETECTING GRAVITATIONAL WAVES

(71) Applicant: STMicroelectronics S.r.l., Agrate Brianza (MB) (IT)

(72) Inventors: Davide Giuseppe Patti, Mascalucia (CT) (IT); Alessandro Mascali, Siracusa (IT); Alfio Russo, Biancavilla (IT)

(73) Assignee: STMicroelectronics S.r.l., Agrate Brianza (MB) (IT)

(21) Appl. No.: 14/041,180

(22) Filed: Sep. 30, 2013

(30) Foreign Application Priority Data
Oct. 9, 2012 (IT) MI2012A001692

(51) Int. Cl. G01V 7/08

(52) U.S. Cl. CPC G01V 7/08
USPC 73/382 R

(57) ABSTRACT

A semiconductor detector of gravitational waves of a first frequency may include an oscillator having a metal coated oscillating member over a metal coated semiconductor substrate to be subjected to a Casimir attraction force towards the semiconductor substrate. The oscillator may be configured to exert a force to counterbalance the Casimir attraction force causing the oscillating member oscillates with a main harmonic resonance frequency equal to the first frequency. A displacement sensor may be coupled to the substrate and oscillating member and configured to sense oscillations and to generate corresponding sense signals. A pass-band filter may be tuned to the main harmonic resonance frequency and configured to generate band-pass replica signals of the sense signals, and an airtight package may be configured to keep a vacuum between the oscillating member and the semiconductor substrate. An array of semiconductor detectors and a method of detecting gravitational waves are also disclosed.

### FIELD OF THE INVENTION

The present invention relates to electronic sensors, and more particularly, to a semiconductor detector of gravitational waves that exploits the Casimir effect.

### BACKGROUND OF THE INVENTION

Gravitational wave detectors have been under development since the 1960s. The long and painstaking research effort has yielded enormous improvements in detector sensitivity. Astronomical observations of binary pulsar systems have confirmed the existence of gravitational radiation. Direct detection is inevitable once planned detectors reach sensitivity goals.

Gravitational waves are vibrations of spacetime, which propagate through space at the speed of light and may be registered as tiny vibrations of carefully isolated masses. Their detection is primarily an experimental science, including the development of ultra-sensitive measurement techniques. While the gravitational waves may be considered as classical waves, the measurement systems may be treated quantum mechanically since the expected signals generally approach the limits set by the uncertainty principle.

After Einstein predicted gravitational waves, a growing number of physicists around the world started to develop different types of antennas to search for gravitational waves. The development of gravitational wave detectors was pioneered by Joseph Weber in the early 1960s. He used a massive aluminum bar as the antenna. Following his work, researchers all over the world have built different types of gravitational wave detectors.

A gravitational wave detector may be constructed from a pair of masses which can move ‘freely’ with respect to each other. They can be suspended as pendulums so that, in the horizontal direction, they can be treated as nearly free masses above the pendulum resonant frequency. A pair of masses connected by a spring may also be used to form a resonant gravitational wave detector.

Resonant-mass detectors are relatively complex and are typically be managed very carefully because the expected mechanical effect of gravitational waves is generally very small. To have detectable effects, the test masses of resonant-mass detectors are typically made such as to be heavier than one ton and to be brought intact at cryogenic temperatures to reduce the thermal noise and to enable the use of high-sensitivity superconducting transducers.

### SUMMARY OF THE INVENTION

Differently from the common trend of research, studies investigating the possibility of detecting measurable effects of gravitational waves using detectors having a very small mass have been performed. This may appear nearly impossible since it is commonly assumed that great masses are typically necessary to observe effects of gravitational waves, but an approach that will be illustrated herein may contradict this statement. More particularly, this approach is based upon a prediction that gravitational waves may induce observable fluctuations of the Casimir force in microelectromechanical systems (MEMS).

The present embodiments address the problem of static deflection and stiction of membranes in microelectromechanical systems, commonly attributed to the well-known Casimir effect between the oscillating membrane and the substrate over which it is suspended. To realize a MEMS with membranes that may vibrate, it may be common to counterbalance the Casimir attraction force with an elastic force such to make the membrane of the MEMS oscillate in a stable manner around an equilibrium point.

Taking into consideration theories proposed in literature about the Casimir force and the non-Newtonian gravitation (M. Bordaag, U. Mohideen, V. M. Mostepanenko, “New Developments in the Casimir Effect”, arXiv:quant-ph/0106045v1; R. Onofrio, “Casimir forces and non-Newtonian gravitation”, New Journal of Physics 8 (2006) 237), the present embodiments of a detector are based upon a theory of interaction between Casimir forces and gravitational waves that predicts observable variations of the former caused by the latter. According to this approach, a detector of gravitational waves exploits the Casimir effect even if the Casimir effect is experienced only in MEMS, that is in devices that have a very small mass.

According to an embodiment, a semiconductor detector of gravitational waves of a first frequency may include an integrated oscillator having a metal coated oscillating member suspended over a metal coated semiconductor substrate to form a planar capacitor with the semiconductor substrate and to be subjected to a Casimir attraction force towards the semiconductor substrate. The integrated oscillator may be configured to exert an elastic force for spacing the oscillating member away from the substrate to counterbalance the Casimir attraction force making the oscillating member free to oscillate in a stable manner around an equilibrium position with a main harmonic resonance frequency substantially equal to the first frequency.

A displacement sensor may be functionally coupled with the substrate and with the oscillating member. The displacement sensor may be configured to sense oscillations of the oscillating member and to generate corresponding sense signals. A pass-band filter may be tuned on the main harmonic resonance frequency and configured to generate band-pass replica signals of the sense signals.

An airtight package of the semiconductor detector may be configured to keep a vacuum in the space between the oscillating member and the semiconductor substrate. Capacitive sensors that have a sub-femtofarad accuracy may be used as displacement sensors of the oscillating member.

A plurality of semiconductor detectors of gravitational waves according to the present embodiments, eventually but not necessarily tuned at different main harmonic resonance frequencies, may be integrated on a same substrate to form an array of singularly addressable and readable detectors of gravitational waves of different frequencies.

A method of detecting gravitational waves is also disclosed.

### BRIEF DESCRIPTION OF THE DRAWINGS

FIGS. 1a and 1b are schematic diagrams of a wavefront of a gravitational wave passing between the plates of a parallel-plates capacitor.

FIG. 2 is a schematic circuit diagram of a semiconductor detector of gravitational waves according to the claimed invention.

FIG. 3 is a schematic diagram of a semiconductor detector of gravitational waves according to the claimed invention.

FIG. 4 is a diagram of an array of semiconductor detectors of gravitational waves according to the claimed invention.

FIG. 5 is another diagram of an array of semiconductor detectors of gravitational waves according to the claimed invention.

### DETAILED DESCRIPTION OF THE PREFERRED EMBODIMENTS

The Casimir force between two finite, parallel, perfectly conducting plates is given by:

$$F ( d ) = - \frac{{K}_{C}}{{d}^{4}} A \qquad ( 1 )$$

where K=π²c/240=1.3×10⁻²⁷ N m², and is Planck's constant and c is the speed of light in vacuum, and A is the surface of plates. This attractive force arises because the plates change the vacuum energy density between the plates from the free-field energy density. Although the force was predicted by Casimir in 1948, it is so small, even at distances of several tenths of a micrometer, that a quantitative measurement was not made until 1998, when an atomic force microscope (AFM) was used to measure the force between a sphere and a plate to an accuracy of 1% (M. Bordaag, U. Mohideen, V. M. Mostepanenko, “New Developments in the Casimir Effect”, arXiv:quant-ph/0106045v1). The challenge of securing parallelism between plates with submicrometer separations may limit the accuracy of force measurements between two plates to about 15% (R. Onofrio, “Casimir forces and non-Newtonian gravitation”, New Journal of Physics 8 (2006) 237).

A relatively simple interpretation of this kind of force arises from the existence of virtual particles as predicted by the uncertainty principle of Heisenberg:

$$Δ E \cdot Δ t \geq \frac{h}{2} \qquad ( 2 )$$

The boundary condition represented by the plates limits the number of wavelengths permitted otherwise outside the plates. The embodiments described herein do not have any limitation. This may cause a net pressure on the plates that acts to reduce the distance d:

$${P}_{c} = \frac{{π}^{2}}{240} \cdot ℏ c \cdot \frac{1}{{d}^{4}} \qquad ( 3 )$$

Virtual particles that have (to maintain their virtuality) a characteristic time or decay time are treated as:

$$τ \approx \frac{ℏ}{Δ E} \qquad ( 4 )$$

For massive particles from the mass-energy equivalence:

$$τ \approx \frac{ℏ}{{mc}^{2}} \qquad ( 5 )$$

For mass-less particles from the Planck relation (E=pc=ω)

$$τ \approx \frac{1}{ω} \qquad ( 6 )$$

In this time τ, the maximum distance traveled is c·τ, and the energy that the particles carry multiplied by this distance is:

E·cτ=c [J×m] (7)

The characteristic energy of the system may be of particular interest, that is:

$$C = \frac{ℏ c}{d} \qquad ( 8 )$$

This is the Casimir quantum that characterizes the system of parallel plates at distance d.

The pressure that acts on the plates can be written as a consequence of a number of negative Casimir quantum energy (the result is an attraction between the plates):

$${P}_{c} = \frac{{π}^{2}}{240} \cdot \frac{ℏ c}{d} \cdot \frac{1}{{d}^{3}} \qquad ( 9 )$$

Another interpretation be that the Casimir effect is a drain of energy

The non-trivial question may then be how many Casimir quanta there are in the system of the present embodiments with parallel and square (L×L) plates. To answer this question, the energy of the system is to be calculated:

$$\begin{matrix}{E}_{c} = - {L}^{2} \frac{K}{3 {d}^{3}} = - {L}^{2} \frac{{π}^{2}}{720} \cdot ℏ c \cdot \frac{1}{{d}^{3}} \\ T hus \text{:} & ( 10 ) \\ N = \frac{{E}_{c}}{C} = \frac{{π}^{2}}{720} \cdot {( \frac{L}{d} )}^{2} & ( 11 )\end{matrix}$$

If the length and the distance of the system are L=100 μm and d=1 μm, respectively, then N˜100. The larger the distance d, the lower the number N of Casimir quanta.

From equations (8) and (11) we can write equation (10) as:

E_{c}=N(d)·C(d) (12)

Thus the uncertainty equation (2) may be written using two conjugate variables (space and momentum):

$$Δ x \cdot Δ p \geq \frac{ℏ}{2} \qquad ( 13 )$$

Indeed, the plates can be seen as a box in which d is the distance between two faces. In this case equation (13) becomes:

$$d \cdot Δ p \geq \frac{ℏ}{2} \\ Δ p \geq \frac{ℏ}{2 d} \\ E = pc \\ Δ E = \frac{ℏ}{2 d} c \qquad ( 14 )$$

and from equation (2)

$$Δ τ \geq \frac{d}{c} \qquad ( 15 )$$

If d=1 μm, and r=10⁻¹⁵ sec.

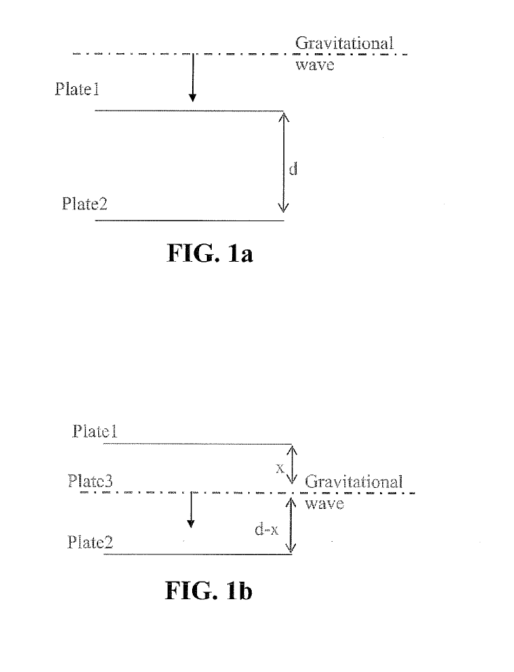

The life time (15) is also the time during which a gravitational wave crosses the system orthogonally to the plates. According to the embodiments, when the gravitational wave is between the plates of the system, another boundary condition should be considered because the wave-front may be considered as another plate, as shown in FIG. 1.

From equation (14) we have:

$$Δ E = \frac{ℏ}{2 x} c$$

$$Δ E = \frac{ℏ}{2 ( d - x )} c$$

From equation (15), for both regions, it is possible to state:

$${τ}^{′} \geq \frac{x}{c}$$

$$and$$

$${τ}^{″} \geq \frac{d - x}{c}$$

This means that the life times of the virtual particles are lower than that before the waves crossing:

τ′≦τ τ″≦τ

If the following equation is considered:

$$x = \frac{d}{2}$$

$$then$$

$${τ}^{′} = {τ}^{″} \geq \frac{1}{2} τ$$

As a consequence of this relation, the virtual particles result in a reduced contribution to balance the external pressure causing an increase of the Casimir force that, on its turn, causes an increase of the capacitance of the MEMS. Indeed, when no wavefront of a gravitational wave is between the plates

$${P}_{c} = \frac{{π}^{2}}{240} \cdot \frac{ℏ c}{d} \cdot \frac{1}{{d}^{3}}$$

When a wavefront of a gravitational wave is between the plates:

$${P}_{c}^{′} = \frac{{π}^{2}}{240} \cdot \frac{ℏ c}{x} \cdot \frac{1}{{x}^{3}} > {P}_{c}$$

$$and$$

$${P}_{c}^{″} = \frac{{π}^{2}}{240} \cdot \frac{ℏ c}{d - x} \cdot \frac{1}{{( d - x )}^{3}} > {P}_{c}$$

Therefore, according to this approach, when a wavefront of a gravitational wave crosses the MEMS, it modifies the total pressure and then the capacitance of the whole system. For this reason it is expected that the functioning of an oscillator that exploits the Casimir effect may be affected by the propagation therethrough of gravitational waves. A variation of the pressure on the plates causes a displacement of the oscillating member of the oscillator, and thus a variation of the capacitance that may be detected using a sensor for detecting the displacement of the oscillating member of the oscillator. Sensors configured to detect this displacement may be, for example, piezoelectric sensors or laser sensors.

According to our embodiment, the sensors may be capacitive sensors. Capacitive sensors may be preferred because recently numerous experiments use sensors with a resolution smaller than one femtofarad. Merely as an example, the article of J. Wei, C. Yue, Z. L. Chen, Z. W. Liu and P. M. Sarro, “A silicon MEMS structure for characterization of femto-farad-level capacitive sensors with lock-in architecture”, J. Micromech. Microeng. 20 (2010) 064019, discloses a technique for testing sensors having a femtofarad resolution. Considering that the capacitance of a two parallel-plate capacitor is inversely proportional to the separation distance d between the plates, and that the distance between two parallel plates in a MEMS system as described above is usually very small, it is expected that even a tiny reduction of this distance d be detected by a capacitance sensor having a femtofarad or sub-femtofarad resolution.

Substantially, the integrated oscillator is an anharmonic Casimir oscillator kept under vacuum and connected to a displacement sensor and a pass-band filter. When a gravitational wave, with a frequency that matches the main harmonic resonance frequency of the oscillator passes through the plates of the capacitor formed by the oscillating member and the substrate, the oscillator resonates and this is a first effect that may be detected.

A second effect that may be detected is a shift of the main harmonic resonance frequency. When a Casimir oscillator is subjected to a pulsed force, its main harmonic resonance frequency varies with respect to the main harmonic resonance frequency at rest (when no gravitational wavefront is present between the oscillating member and the substrate). By measuring this shift of the resonance frequency, it may be possible to detect gravitational waves.

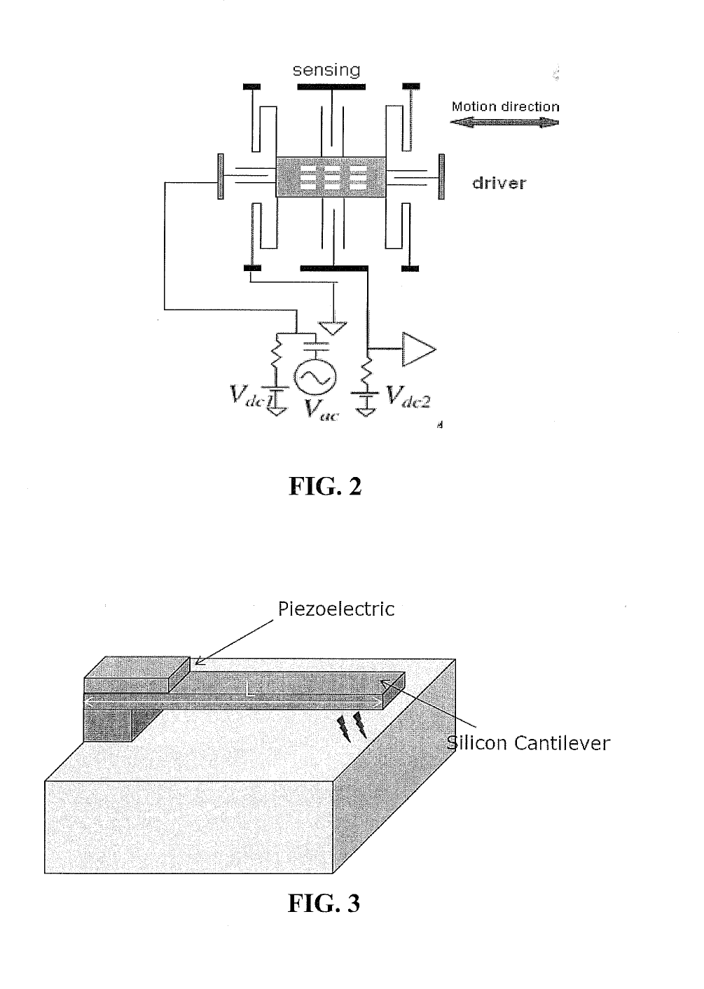

An example of a detector of gravitational waves made with a MEMS technology connected to a capacitance meter is shown in FIG. 2. It includes an integrated oscillator working in the Casimir region of functioning, a displacement sensor for sensing displacements of the oscillating member of the oscillator, and a pass-band filter tuned on the main harmonic resonance frequency of the oscillating member. An airtight package keeps a vacuum in the space between the oscillating member and the semiconductor substrate to make the oscillating member free to oscillate without compressing/expanding air eventually trapped between the oscillating member and the substrate.

The MEMS oscillator may be conveniently designed to make the oscillating member free to oscillate because of gravitational waves without incurring stiction. To have capacitance variations as great as possible, it may be desirable that the separation distance d between the plates be as short as possible. The skilled person is capable of determining a value of the separation distance d to have stable oscillations depending on the materials of the oscillating member and on the forces that may act thereon.

According to an embodiment, the oscillator, as schematically illustrated in FIG. 3, may be formed with a silicon cantilever beam having a length L suspended over a substrate at a distance d to be subjected to a non-negligible Casimir force. The cantilever beam is connected to a piezoelectric sensor configured to sense vibrations of the beam. By adjusting the length L of the beam, it may be possible to set the main harmonic resonance frequency of this oscillator.

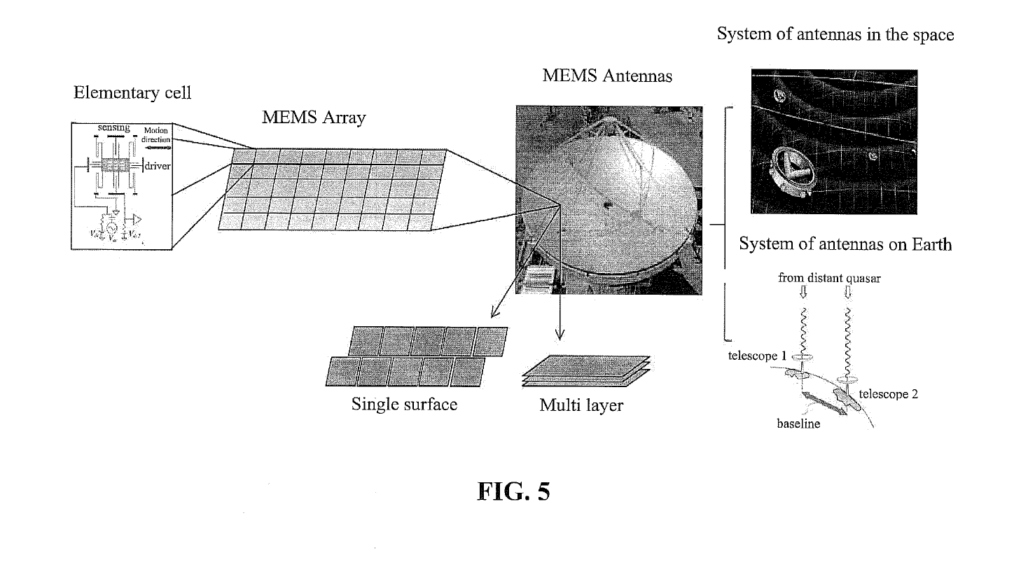

A plurality of singularly readable detectors of gravitational waves may be integrated on a same semiconductor substrate to form an array of semiconductor detectors, as schematically illustrated in FIG. 5 referring to the embodiment of FIG. 2.

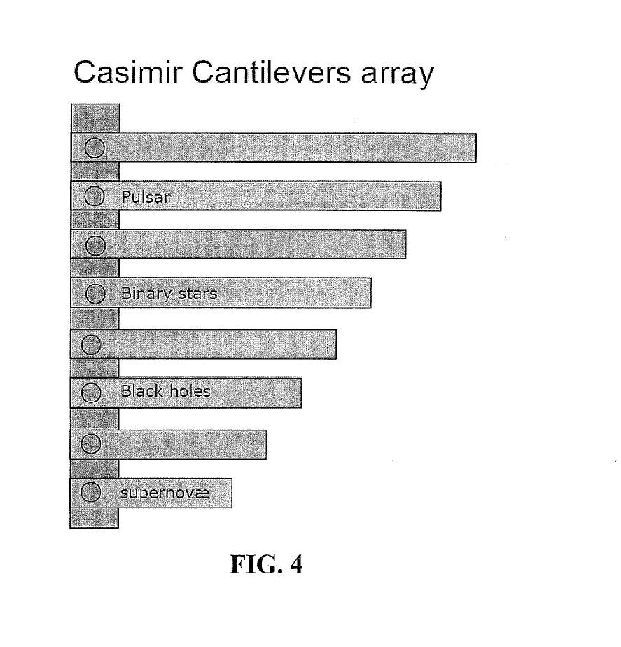

According to an embodiment, an array includes detectors adapted to resonate at different main harmonic resonance frequencies. An example of such an array formed, referring to the embodiment of FIG. 3, is shown in FIG. 4. A gravitational wave generally will not induce resonance in all the resonators of the array, but only in the resonators that are tuned at the frequency of the gravitational wave. Therefore, by comparing the amplitude of oscillations of different detectors of the array it may be possible to discriminate oscillations due to mechanical vibration of the substrate (that may act irrespectively on all detectors) from oscillations caused by gravitational waves (that may act only on tuned detectors).

1-8. (canceled)

9. A semiconductor detector of gravitational waves of a first frequency comprising:
an integrated oscillator comprising
a semiconductor substrate,
an electrically conductive layer on said semiconductor substrate, and
an electrically conductive oscillating member over said electrically conductive layer defining a planar capacitor therewith to be subjected to a Casimir attraction force towards said semiconductor substrate,
said integrated oscillator being configured to exert an elastic force for spacing said electrically conductive oscillating member away from said semiconductor substrate to counterbalance the Casimir attraction force thus making said electrically conductive oscillating member free to oscillate around an equilibrium position with a main harmonic resonance frequency equal to the first frequency;
a displacement sensor coupled to said semiconductor substrate and said electrically conductive oscillating member, and configured to sense oscillations of said electrically conductive oscillating member and generate corresponding sense signals;
a pass-band filter tuned on the main harmonic resonance frequency, and configured to generate band-pass replica signals of the sense signals; and
an airtight package configured to maintain a vacuum in a space between said electrically conductive oscillating member and said semiconductor substrate.

10. The semiconductor detector of claim 9, wherein said displacement sensor comprises a capacitive displacement sensor configured to generate the sense signals representing a capacitance determined based upon said electrically conductive oscillating member and said semiconductor substrate.

11. The semiconductor detector of claim 10, wherein said capacitive displacement sensor has a sub-femtofarad resolution.

12. The semiconductor detector of claim 9, wherein said displacement sensor comprises a piezoelectric displacement sensor configured to generate the sense signals representing a position of said electrically conductive oscillating member.

13. A semiconductor detector of gravitational waves of a first frequency comprising:
a semiconductor substrate;
an electrically conductive layer on said semiconductor substrate;
an electrically conductive oscillating member over said electrically conductive layer defining a capacitor therewith to be subjected to a Casimir attraction force towards said semiconductor substrate;
said electrically conductive oscillating member being configured to counterbalance the Casimir attraction force and oscillate around an equilibrium position with a main harmonic resonance frequency equal to the first frequency;
a displacement sensor configured to sense oscillations of said electrically conductive oscillating member and generate corresponding sense signals;
a filter coupled to said displacement sensor and tuned on the main harmonic resonance frequency; and
an airtight package configured to maintain a vacuum in a space between said electrically conductive oscillating member and said semiconductor substrate.

14. The semiconductor detector of claim 13, wherein said displacement sensor comprises a capacitive displacement sensor.

15. The semiconductor detector of claim 14, wherein said capacitive displacement sensor has a sub-femtofarad resolution.

16. The semiconductor detector of claim 13, wherein said displacement sensor comprises a piezoelectric displacement sensor.

17. An array of semiconductor detectors of gravitational waves comprising:
a semiconductor substrate;
a plurality of addressable semiconductor detectors carried by said semiconductor substrate, and each comprising
an electrically conductive layer on said semiconductor substrate,
an electrically conductive oscillating member over said electrically conductive layer defining a capacitor therewith to be subjected to a Casimir attraction force towards said semiconductor substrate,
said electrically conductive oscillating member being subject to an elastic force for spacing said electrically conductive oscillating member away from said semiconductor substrate to counterbalance the Casimir attraction force thus making said electrically conductive oscillating member free to oscillate around an equilibrium position with a main harmonic resonance frequency equal to the first frequency,
a displacement sensor coupled to said semiconductor substrate and said electrically conductive oscillating member, and configured to sense oscillations of said electrically conductive oscillating member and generate corresponding sense signals,
a filter tuned on the main harmonic resonance frequency, and configured to generate replica signals of the sense signals, and
an airtight package configured to maintain a vacuum in a space between said electrically conductive oscillating member and said semiconductor substrate; and
a selection and read circuit coupled to said plurality of addressable semiconductor detectors and configured to select and read the replica signals generated by each of said plurality of addressable semiconductor detectors.

18. The array of claim 17, wherein said displacement sensor comprises a capacitive displacement sensor.

19. The array of claim 18, wherein said capacitive displacement sensor has a sub-femtofarad resolution.

20. The array of claim 17, wherein said displacement sensor comprises a piezoelectric displacement sensor.

21. The array of claim 17, wherein said plurality of addressable semiconductor detectors are each tuned at different main harmonic resonance frequencies.

22. A method of using at least one semiconductor detector comprising an semiconductor substrate, an electrically conductive layer carried by the semiconductor substrate, an electrically conductive oscillating member over the electrically conductive layer defining a capacitor therewith to be subjected to a Casimir attraction force towards the semiconductor substrate, the electrically conductive oscillating member being configured to counterbalance the Casimir attraction force and oscillate around an equilibrium position with a main harmonic resonance frequency equal to the first frequency, and an air-tight package configured to maintain a vacuum in a space between the electrically conductive oscillating member and the semiconductor substrate, the method comprising:
sensing oscillations, using a displacement sensor coupled to the semiconductor substrate and the electrically conductive oscillating member, of the electrically conductive oscillating member and generating corresponding sense signals; and
generating, using a filter tuned on the main harmonic resonance frequency, replica signals of the sense signals.
comparing an amplitude of the replica signals with a threshold; and
generating output signals indicative of a gravitational wave being detected based upon exceeding the threshold.

23. The method of claim 22, further comprising comparing an amplitude of the replica signals with a threshold.

24. The method of claim 23, further comprising generating output signals indicative of a gravitational wave being detected based upon exceeding the threshold.

25. The method of claim 22, wherein the displacement sensor comprises a capacitive displacement sensor.

26. The method of claim 22, wherein the displacement sensor comprises a piezoelectric displacement sensor.

27. The method of claim 22, wherein the at least one semiconductor detector comprises a plurality of semiconductor detectors each being oriented in a different direction.

28. The method of claim 27, further comprising:
measuring the main harmonic resonance frequency of each of the plurality of semiconductor detectors; and
comparing an absolute value of a difference between the main harmonic resonance frequencies with a threshold.

29. The method of claim 28, further comprising generating output signals indicative of a gravitational wave being detected based upon exceeding the threshold.
